(19) United States
(12) Patent Application Publication
(10) Pub. No.: US 2014/0251051 A1
(43) Pub. Date: Sep. 11, 2014

(54) RANGE SWITCHING DEVICE

(71) Applicant: DENSO CORPORATION, Kariya-city (JP)

(72) Inventor: Jun YAMADA, Nagoya-city (JP)

(73) Assignee: DENSO CORPORATION, Kariya-city (JP)

(21) Appl. No.: 14/194,852

(22) Filed: Mar. 3, 2014

(30) Foreign Application Priority Data
Mar. 6, 2013 (JP) 2013-43777

(51) Int. Cl. F16H 59/08

(52) U.S. Cl. CPC F16H 59/08
USPC 74/473.12

(57) ABSTRACT

A range switching device has a range switch mechanism driven by a motor and a control unit in the range switching device performs an abutment control for controlling the motor when a shift range is a range other than a P range at a start time of the control unit, based on a determination whether a switch permission condition is being fulfilled. The fulfillment of such a condition is determined based on a brake ON state of a vehicle and an IG switch ON state. When the switch permission condition is determined as fulfilled, the shift range is switched to the P range and the motor is rotated to perform the abutment control for learning a reference position.

### CROSS REFERENCE TO RELATED APPLICATION

The present application is based on and claims the benefit of priority of Japanese Patent Application No. 2013-043777, filed on Mar. 6, 2013, the disclosure of which is incorporated herein by reference.

### TECHNICAL FIELD

The present disclosure generally relates to a range switching device that switches a shift range with a motor.

### BACKGROUND INFORMATION

In recent years, manual operations of apparatuses within vehicles, as well as in other devices, are increasingly being replaced by motor-driven operations that utilize electric motors. Motor-driven operations provide many benefits, such as space-savings, ease of assembly, improved controllability and the like. The replacement of an automatic transmission range switching mechanism within a vehicle is an example of such a replacement from manual operation to motor-driven operation. Such a mechanism is equipped with an encoder that is synchronized with the motor and outputs a pulse signal at every given angle of rotation of the motor. In operation, when a gear shift position of the automatic transmission is changed, the motor is driven to a target rotation position that corresponds to a target shift range and the automatic transmission is shifted to the target shift range.

In such a system, the motor is rotated to a limit position of a movable range of the range switch mechanism, which may be designated as an abutment control of the motor, upon starting an operation of a control unit. Such a limit position is learned as a reference position for subsequent control of the motor rotation angle, such as the motor rotation amount.

Further, a patent document 1 (i.e., Japanese Patent Laid-Open No. 2006-136035) discloses a system for performing a P range side abutment control and then a D range side abutment control to improve range switching accuracy based on an overshoot control. When utilizing such an overshoot control scheme, the motor rotation position for the range switching operation is intentionally overshot past a legitimate target rotation position. The motor rotation position is then returned to the legitimate target rotation position, until the system learns how much play is within a rotation transmission mechanism by performing one round of shift switching after P range side abutment control, i.e., after performing a P range side abutment control followed by a switching from P to R to N to D range.

When the control unit is started, the shift range is an “abutted shift range” in which the abutment control is performable. As such, in order to learn a reference position, the abutment control is performed immediately. However, the shift range at the control unit operation start time may not always be in the abutted shift range. For example, the shift range at the control unit operation start time may not always be in the P range. Therefore, when the shift range is not an abutted shift range, the reference position cannot be immediately learned based on the abutment control of patent document 1.

The technique in the above-mentioned patent document 1 applies only to an “afterward” situation of post-learning time, i.e., a situation after learning the reference position based on an abutment control on a P range side or on a D range side. That is, the technique of the patent document 1 does not solve the above-described problem.

### SUMMARY

It is an object of the present disclosure to provide a range switching device which learns a reference position by performing an abutment control when a position of a shift range is not in an abutted shift range at a time of starting a control unit.

In an aspect of the present disclosure, the range switching device includes a range switch mechanism having a plurality of shift ranges, a motor driving the range switching mechanism to switch a shift range between one of the plurality of shift ranges, and a control unit controlling the motor to rotate the range switching mechanism to the shift range. The control unit determines (A) in the range switching device that is configured to rotate the motor after a start of operation of the control unit and perform an abutment control in which the motor is rotated to a limit position of the range switch mechanism and learns a reference position, whether the shift range is an abutted shift range that allows the abutment control to be performed at the start of operation of the control unit, and (B) if the shift range is determined to be a shift range other than the abutted shift range, the control unit determines whether a predetermined switch permission condition is fulfilled, and (C) if the predetermined switch permission condition is fulfilled, the control unit switches the shift range to the abutted shift range and learns the reference position based on a limit position of the abutted shift range.

In such a configuration, even when the shift range is a range other than the abutted shift range at an operation start time of the control unit, if the switch permission condition is determined as fulfilled, the shift range is switched to the abutted shift range for performing an abutment control and the reference position is thus learned. In such manner, the motor rotation angle (i.e., the motor rotation amount) is accurately controlled with reference to the reference position that is learned immediately after the operation start time of the control unit.

### BRIEF DESCRIPTION OF THE DRAWINGS

Objects, features, and advantages of the present disclosure will become more apparent from the following detailed description made with reference to the accompanying drawings, in which:

FIG. 1 is a perspective view of a range switching device in a first embodiment of the present disclosure;

FIG. 2 is a block diagram of a control system configuration regarding the range switching device;

FIG. 3 is an illustration of a detent lever having a plurality of range detention concave positions corresponding to a plurality of shift ranges;

FIG. 4 is a flowchart of a reference position learning routine in the first embodiment of the present disclosure;

FIG. 5 is a time chart of a first example of reference position learning in the first embodiment of the present disclosure;

FIG. 6 is a time chart of a second example of reference position learning in the first embodiment of the present disclosure;

FIG. 7 is a flowchart of the reference position learning routine in a second embodiment of the present disclosure;

FIG. 8 is a time chart of an example of reference position learning in the second embodiment of the present disclosure; and

FIG. 9 is a flowchart of a reference position learning routine in a third embodiment of the present disclosure.

### DETAILED DESCRIPTION

Embodiments materializing the present disclosure hereafter are described in the following.

### First Embodiment

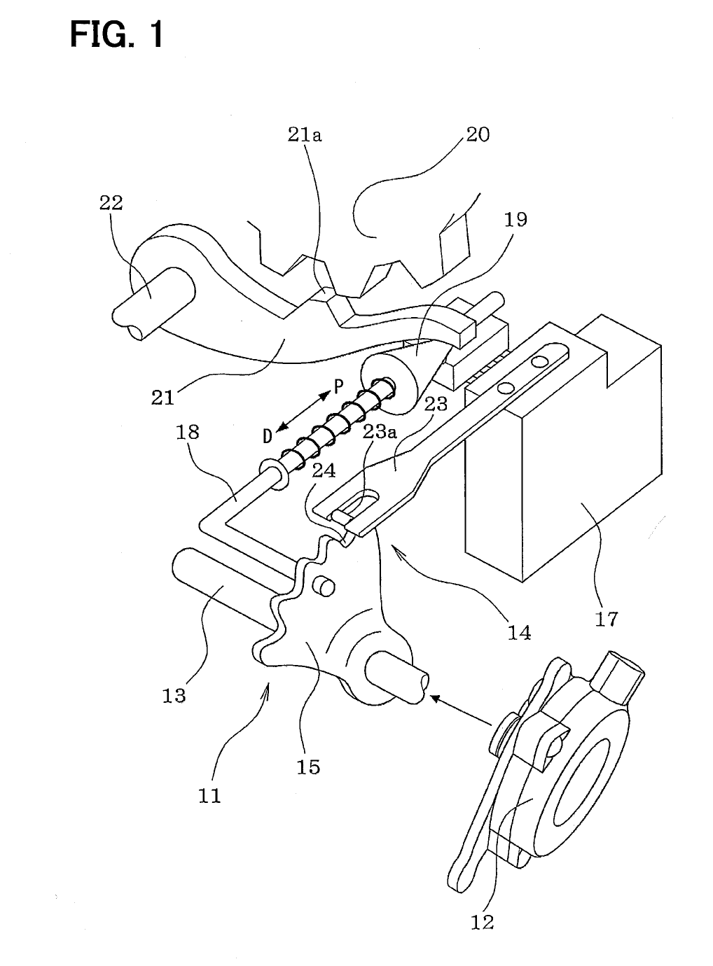

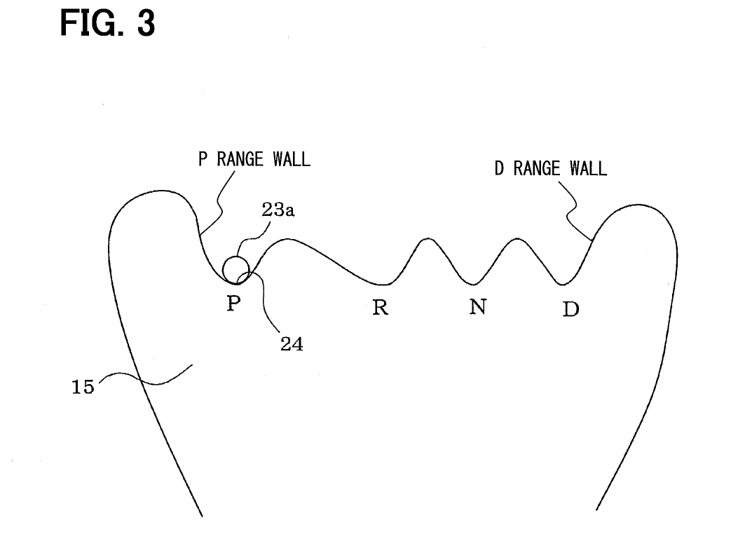

The first embodiment of the present disclosure is described with reference to FIG. 1 to FIG. 6.

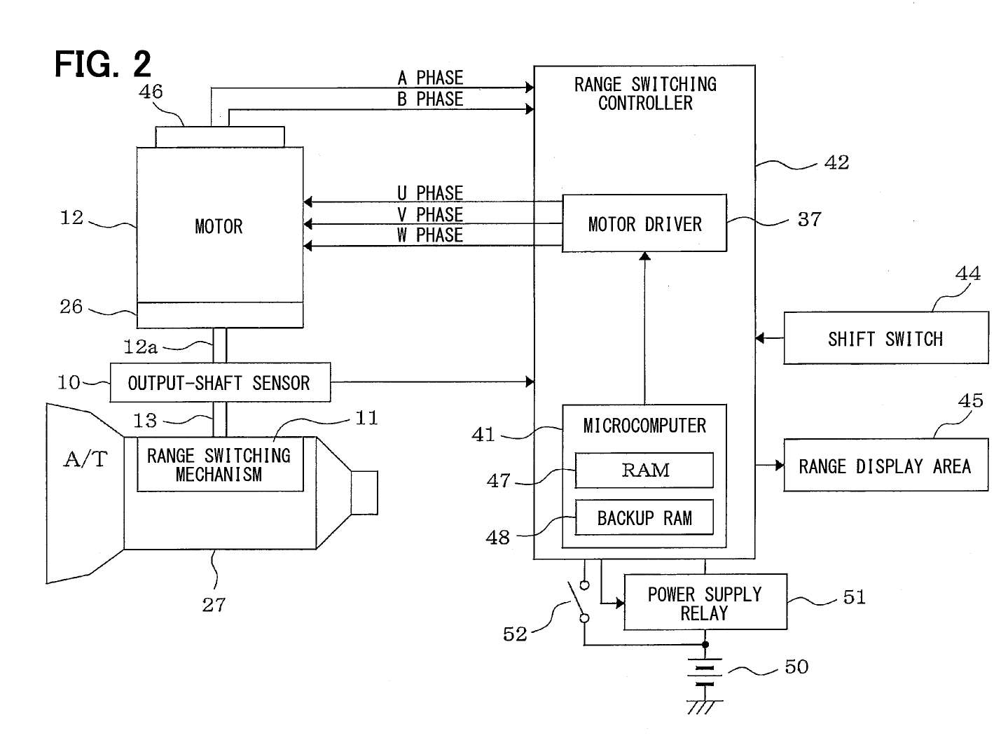

First, a structure of a range switch mechanism 11 is described with reference to FIG. 1 and FIG. 2.

As shown in FIG. 1, the range switching mechanism 11 is a 4-position type range switching mechanism for switching the shift range of an automatic transmission 27 (see FIG. 2) among four positions, which may include a P range (i.e., a parking range), an R range (i.e., a reverse range), an N range (i.e., a neutral range), and a D range (i.e., a drive range). The motor 12 may be a switched-reluctance motor, for example, which may be used to drive the range switching mechanism 11. As shown in FIG. 2, the motor 12 has a built-in deceleration mechanism 26. The motor 12 is also attached to an output-shaft sensor 10 for detecting a rotation position of an output shaft 12a. The output shaft 12a of the motor 12 is connected to a manual shaft 13 and a detent lever 15 is attached to the manual shaft 13.

The detent lever 15 is connected to a manual valve (not illustrated) which performs a linear motion according to a rotation of the detent lever 15. Such a manual valve is used to switch to an internal hydraulic circuit (not shown) within an inside of the automatic transmission 27.

A parking rod 18 is formed in an L-shape and fixed onto the detent lever 15. A cone body 19 is provided at a tip part of the parking rod 18 and in contact with a locking lever 21. According to the position of the cone body 19, the locking lever 21 moves (i.e., rotates) up and down centering on the shaft 22 to lock and unlock a parking gear 20. The parking gear 20 is disposed on the output axis of the automatic transmission 27, and, when the parking gear 20 is locked by the locking lever 21, the driving wheels of the vehicle are held in a locked state (i.e., a parking state) in which the wheels are prevented from rotating.

A detent spring 23 is fixed on a support base 17 and holds the detent lever 15 in each of the P, R, N, and D ranges. The detent lever 15 has a range detention concave part 24 (see FIG. 1) for each of the P, R, N, and D range, and, when an engagement part 23a provided at the tip of the detent spring 23 is engaged with one of the range detention concave parts 24, the detent lever 15 is held in the position of each of those ranges. In combination, the detent lever 15 and the detent spring 23 serve as the detent mechanism 14 (i.e., a detent) to engaging and hold the rotation position of the detent lever 15 within one of the four ranges (i.e., a device for holding the range switching mechanism 11 at one of the plural range positions).

In the P range, the parking rod 18 moves closer to the locking lever 21 such that a thick portion of the cone body 19 pushes the locking lever 21 upward. In turn, a convex part 21a of the locking lever 21 engages the parking gear 20 to lock the parking gear 20 and hold the output shaft (i.e., driving wheels) of the automatic transmission 27 in a locked state (i.e., a parking state of the vehicle).

In the R, N, and D ranges, the parking rod 18 moves away from the locking lever 21 such that the thick portion of the cone body 19 is pulled out from below the locking lever 21. In turn, the lever 21 moves downward and the convex part 21a of the locking lever 21 moves away from the parking gear 20 to release the lock of the locking lever 21. As a result, the output shaft of the automatic transmission 27 is rotatable state (i.e., a travelable state of the vehicle).

Further, the output-shaft sensor 10 mentioned above includes a rotation sensor (e.g., a potentiometer) which outputs a voltage according to the rotation angle of the output shaft 12a of the deceleration mechanism 26 of the motor 12. In addition, which of the P, R, N and D ranges for shifting into is confirmed based on the output voltage. Further, if no output-shaft sensor 10 is provided, an encoder 46 confirms which one of the P, R, N and D ranges is the actual shift range.

As shown in FIG. 2, the encoder 46 is provided in the motor 12 to detect the rotation angle (i.e., a rotation position) of a rotor. The encoder 46 is implemented as a magnetic type rotary encoder, for example, and is configured to output a pulse signal of an A phase and a pulse signal of a B phase that is in synchronization with the rotation of the rotor of the motor 12. The encoder 46 outputs the pulse signal to a range switching controller 42 at every predetermined angle. The microcomputer 41 of the range switching controller 42 counts both a rising edge and a falling edge of the A phase signal and the B phase signal, which are then outputted from the encoder 46. The motor 12 is rotated based on the switching of the power supply phases of the motor 12 in a given order by a motor driver 37 according to the count value (hereinafter encoder count value). Further, two systems (i.e., two combinations) of three-phase (U, V, W phase) windings of the motor 12 and the motor driver 37 may be provided for the contingency operation of the motor 12. That is, operation of the motor 12 may continue through the use of one functioning system even despite the malfunctioning of the other of the two systems.

During the rotation of the motor 12, a rotation direction of the motor 12 is determined based on an order of generating the A phase signal and the B phase signal. The encoder count value is counted upward when the rotation direction is determined as a positive rotation (i.e., a rotation direction from the P range toward the D range), and the encoder count value is counted downward when the rotation direction is determined as a reverse rotation (i.e., a rotation direction from the D range toward the P range). Since the correspondence between the encoder count value and the rotation angle of the motor 12 is maintained in both of the two rotation directions of the motor 12, the rotation of the motor 12 in both of the two rotation directions is controllable by the power supply for the winding in a corresponding phase that corresponds to the rotation position of the motor 12 based on the rotation position detected by the encoder count value.

A signal of a shift lever operation position detected by the shift switch 44 is input to the range switching controller 42. According to such input, that is, according to the driver's operation of the shift lever, the microcomputer 41 (i.e., a control unit) of the range switching controller 42 switches a target shift range, and drives the motor 12 according to the target shift range to switch the shift range. After the switching of the shift ranges, the controller 42 displays the actual shift range on a range display area 45 that is disposed on an instrument panel (not shown).

A power supply voltage is supplied for the range switching controller 42 via a power supply relay 51 from a battery 50 (i.e., a power supply) in the vehicle. The ON and OFF of the power supply relay 51 are switched by manually operating/switching an IG switch 52 ON and OFF (i.e., an ignition switch) which is an electric power switch. When the IG switch 52 is turned ON, the power supply relay 51 is turned ON and the power supply voltage is supplied for the range switching controller 42. When the IG switch 52 is turned OFF, the power supply relay 51 is turned OFF and the power supply for the range switching controller 42 is interrupted (i.e., is turned OFF).

In this case, since the encoder count value is memorized in RAM 47 of the microcomputer 41, when the power supply of the range switching controller 42 is turned OFF, a memory of the encoder count value is lost. Therefore, the encoder count value immediately after the turning ON of the range switching controller 42 may not correspond to the actual rotation position (i.e., the power supply phase) of the motor 12. Thus, in order to switch the power supply phases according to the encoder count value, it is necessary for the encoder count value to correspond to the actual rotation position of the motor 12 after the turning ON of the power supply, for the correspondence between the encoder count value and the power supply phase.

Therefore, the microcomputer 41 performs a learning process in which a correspondence between the power supply phase of the motor 12 and the encoder count value is learned, in an initial drive after the turning ON of the power supply. In such an initial drive, the switching of the power supply phases of the motor 12 is performed for one rotation by the open-loop control at a scheduled timing, so that the correspondence between the rotation position of the motor 12 and the power supply phase of the motor 12 is matched in one of the power supply phases, for the driving of the motor 12 and for counting the edges of the A phase signals and the B phase signals of the encoder 46. In such manner, by the time of ending the initial drive, the correspondence between (i) the encoder count value, (ii) the rotation position of the motor 12 and (iii) the power supply phase is learned.

Further, since the microcomputer 41 can only detect an amount of rotation (i.e., a rotation angle) from a start position of the motor 12 based on the encoder count value after starting of the motor 12, an absolute rotation position must be detected by after the turning ON of the motor 12, in order to accurately rotate the motor 12 to the target rotation position.

Therefore, the microcomputer 41 performs an abutment control after ending the initial drive in which the microcomputer 41 rotates the motor 12 to a limit position of the movable range of the range switch mechanism 11, learns the limit position as a reference position, and controls the rotation amount (i.e., the rotation angle) of the motor 12 with reference to an encoder count value of this reference position. In the present embodiment, the P range is designated as an “abutted shift range”, i.e., a shift range in which the abutment control is performable.

Therefore, when the shift range is the P range, a “P range wall abutment control” is performed, which rotates the motor 12 until the engagement part 23a of the detent spring 23 abuts against a P range wall (i.e., a side wall of the P range detention concave part 24) that is the limit position on a P range side of the movable range of the range switch mechanism 11, and by which the limit position on the P range side is learned as a reference position.

After the learning of the reference position, when the target range is switched according to a manual operation of the shift lever by the driver, the microcomputer 41 performs a feedback control for rotating the motor 12 to the target rotation position. To perform the feedback control, the microcomputer 41 changes a target rotation position (i.e., a target count value) according to the manual operation of the shift lever and sequentially switches the power supply phases of the motor 12 based on the encoder count value, for switching the shift range to the target range (i.e., for the switching of a switch position of the range switch mechanism 11 to a position of the target range).

The above-described learning of the reference position applies to a specific case, in which, at a time of starting the microcomputer 41, the shift range is the “abutted shift range” that allows the abutment control, thereby the abutment control is performed immediately to learn a reference position. However, the shift range at a time of starting the microcomputer 41 may not always be the abutted shift range, that is, not always the P range in the present embodiment. That is, when the shift range is a range other than the abutted shift range, e.g., a range other than the P range, the reference position cannot be learned immediately by performing the abutment control.

Thus, if the shift range is a range other than the abutted shift range (i.e., a range other than the P range in the present embodiment) when the microcomputer 41 is started, the microcomputer 41 of the range switching controller 42 determines whether a predetermined switch permission condition has been fulfilled. If determined that the switch permission condition has been fulfilled, the microcomputer 41 switches the shift range to the abutted shift range (i.e., to the P range in the present embodiment) and performs the abutment control for the learning of the reference position.

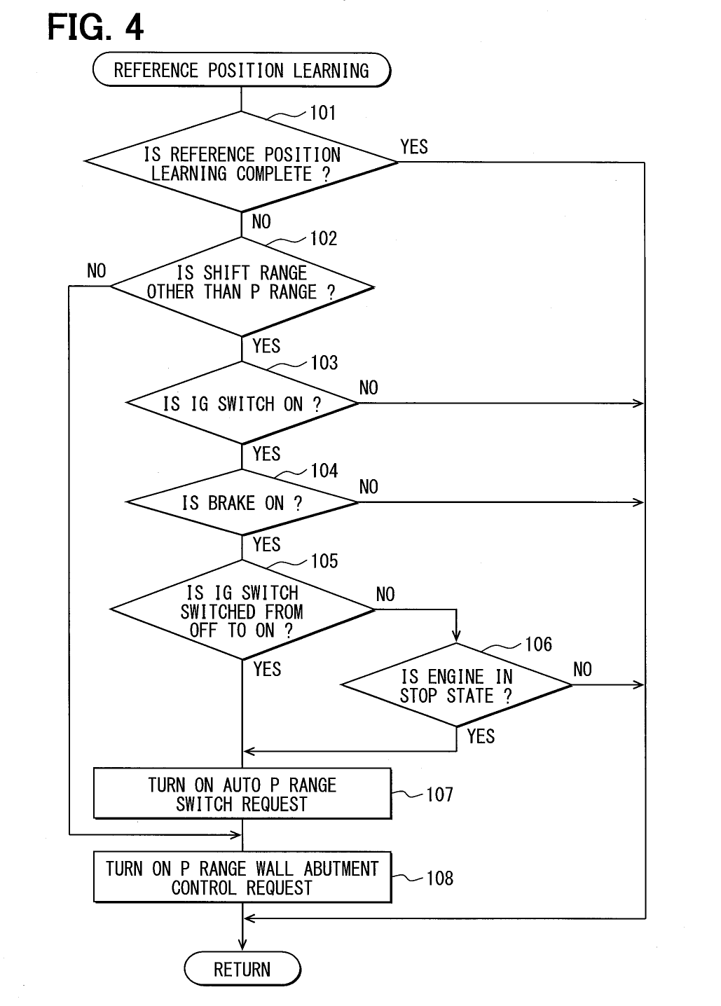

More specifically, the microcomputer 41 of the range switching controller 42 performs a reference position learning routine in FIG. 4 which is described in the following, for the abutment control in an other-than abutted shift range case. That is, when the shift range is a range other than the P range (i.e., an R range, or an N range, or a D range) at a time of starting the microcomputer 41, the microcomputer 41 determines whether the switch permission condition has been fulfilled, by examining whether (i) a brake of the vehicle is ON (i.e., a brake is being operated) and (ii) an IG switch 52 (i.e., ignition switch) is turned ON. When the brake is ON and the IG switch 52 is ON, the microcomputer 41 determines that the switch permission condition is fulfilled, thereby, switching the shift range to the P range and performing the P range wall abutment control, for the learning of the reference position.

Hereafter, the contents of the reference position learning routine in FIG. 4 which is performed by the microcomputer 41 of the range switching controller 42 are described.

The reference position learning routine shown in FIG. 4 is repeatedly executed at a predetermined interval by the microcomputer 41 during a power ON period of the range switching controller 42. After a start of this routine, the routine determines in Step 101 whether a reference position learning is complete and whether a reference position learning completion flag is set to “1”, which indicates a completion of the reference position learning. The reference position learning completion flag is reset to “0” at the start-up of the microcomputer 41, and is set to “1” thereafter when the reference position learning is complete.

This routine ends without performing Step 102 and after it is determined that the reference position learning routine is complete in Step 101. On the other hand, when it is determined that the reference position learning routine has not yet completed in the above-mentioned Step 101, the routine proceeds to Step 102, and it is determined whether the present shift range is one of the other ranges other than the P range (i.e., the R range, the N range, or the D range).

In Step 102, when it is determined that the present shift range is the P range, the routine proceeds to Step 108 with a determination that the abutment control is performable in the present range, and turns ON a P range wall abutment control request (i.e., the routine requests for an abutment control). In such manner, the P range wall abutment control is performed, and the P range side limit position is learned as a reference position.

On the other hand, when it is determined that the present shift range is a range other than the P range in the above-mentioned Step 102, it is determined that the abutment control cannot be performed in the present range, and determines in the subsequent Steps 103, 104 whether the switch permission condition is being fulfilled. First, the routine determines whether the IG switch 52 is turned ON in Step 103. Then, it is determined in the following Step 104 whether the brake is ON, based on whether a brake switch is being turned ON, for example.

When it is determined that the IG switch 52 is being turned OFF (i.e., in an OFF state) in the above-mentioned Step 103, or when it is determined that the brake is OFF in the above-mentioned Step 104, the routine determines that the switch permission condition is not being fulfilled, and the routine is ended.

When, on the other hand, it is determined that the IG switch 52 is turned ON in the above-mentioned Step 103 and it is determined that the brake is ON in the above-mentioned Step 104, the routine proceeds to Step 105 with a determination that the switch permission condition is being fulfilled. Then, it is determined whether it is a timing immediately after a switching on of the IG switch 52 from OFF to ON (i.e., whether it is a first time determination that the IG switch 52 is being turned ON in the present execution cycle of the routine after starting the microcomputer 41).

When it is determined that it is the timing immediately-after a switching on of the IG switch 52 in Step 105 (i.e., it is immediately after the switching on of the IG switch 52 switched from OFF to ON), it is considered that the IG switch 52 is turned ON after the brake is turned ON, and the routine proceeds to Step 107, and switches the shift range to the P range by turning ON an automatic P range switching request. Then, the routine proceeds to Step 108, and the routine turns ON the P range wall abutment control request. In such manner, the P range wall abutment control is performed, and the P range side limit position is learned as a reference position.

On the other hand, when it is determined that it not an immediately-after timing of the switching of the IG switch 52 from OFF to ON, the routine proceeds to Step 106 to determine whether an engine of the vehicle is in a stopped state (i.e., it is before a start of the engine), assuming that the engine of the vehicle might have already been started since the brake is turned ON after the turning ON of the IG switch 52.

At Step 106, when it is determined that the engine is in a stopped state, the routine proceeds to Step 107, and turns ON the automatic P range switching request, and the shift range is switched to the P range, based on a determination that switching of the shift range is OK (i.e., safe). Then, the routine proceeds to Step 108, and turns ON the P range wall abutment control request. Thereby, the P range wall abutment control is performed, and the P range side limit position is learned as a reference position.

On the other hand, when it is determined that the engine is not in a stopped state (i.e., the engine is in operation), the routine determines that it is better not to switch the shift range, and the routine is ended.

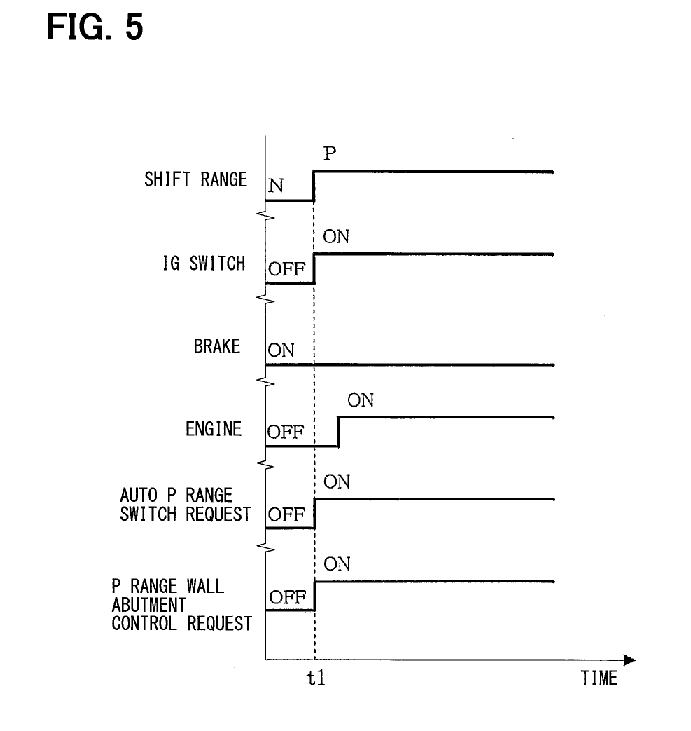

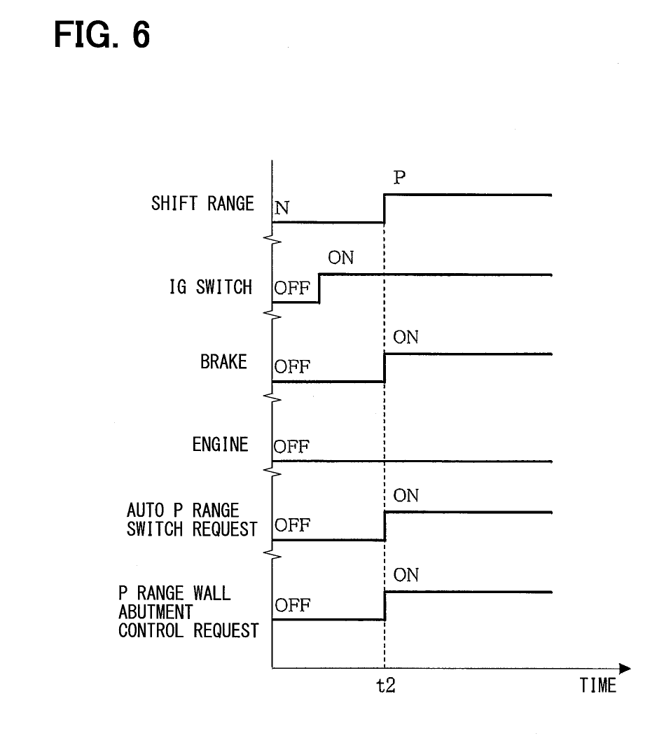

An example of how the reference position learning is performed in the first embodiment is described with reference to time charts in FIGS. 5 and 6.

As shown in FIGS. 5 and 6, at a time of starting the microcomputer 41 of the range switching controller 42, whether the switch permission condition is being fulfilled is determined based on whether the IG switch 52 is being turned ON and whether the brake is turned ON (e.g., the brake switch is being turned ON) in case that the shift range is the N range (i.e., the shift range is other than the abutted shift range).

When the IG switch 52 is turned ON after the brake is turned ON as shown in FIG. 5, the routine determines that the switch permission condition is being fulfilled, and, at a time t1 of such fulfillment determination, the routine turns ON the automatic P range switching request, and the shift range is switched to the P range. Further, the routine turns ON the P range wall abutment control request, and the P range wall abutment control is performed, and the P range side limit position is learned as a reference position.

On the other hand, when the brake is turned ON after the IG switch 52 is turned ON as shown in FIG. 6, the routine determines that the switch permission condition is being fulfilled, but the routine further determines whether the engine is in a stopped state (i.e., it is before a start of the engine), and, at a time t2 of such determination that the engine is in a stopped state, the routine turns ON the automatic P range switching request, and the shift range is switched to the P range. Further, the routine turns ON the P range wall abutment control request, and the P range wall abutment control is performed, and the P range side limit position is learned as a reference position.

In the first embodiment described above, at a time of starting the microcomputer 41, if the shift range is a range other than the P range (i.e., the R range, or the N range, or the D range), the routine determines whether a predetermined switch permission condition is being fulfilled, and, if it is determined that the switch permission condition is being fulfilled, the routine switches the shift range to the P range, and the P range wall abutment control is performed, and a reference position is learned. In such manner, even when the shift range is a range other than the P range at a time of starting the microcomputer 41, if it is determined that the switch permission condition is being fulfilled, the shift range can be switched to the P range and the P range wall abutment control can be performed, thereby enabling the learning of a reference position, and the rotation angle (i.e., the rotation amount) of the motor 12 is controlled with a sufficient accuracy based on a reference position.

Further, in the first embodiment, when the brake is ON and the IG switch 52 is ON, the routine is configured to determine that the switch permission condition is being fulfilled, which allows the switching of the shift range to the P range only in a brake ON state (i.e., only when the brake is being turned ON), thereby improving the safety. Further, in case that the range switching device is applied to a system that has the microcomputer 41 in a turned ON state during a turn OFF period of the IG switch 52, the above-described range switching scheme prevents an unintentional switching of the shift range during an OFF period of the IG switch 52, which is a period when the driver has no intention of driving the vehicle (i.e., when there is no need to perform a reference position learning routine.

Further, although it is configured in the above-mentioned first embodiment that the switch permission condition is determined as being fulfilled when the brake is ON and the IG switch 52 is turned ON, such configuration may be modified and/or changed. That is, for example, in a system that has the microcomputer 41 in a turned OFF state during a turn OFF period of the IG switch 52, the determination of whether the IG switch 52 is ON may be omitted, and the routine may determine that the switch permission condition is being fulfilled simply based on a brake ON state.

### Second Embodiment

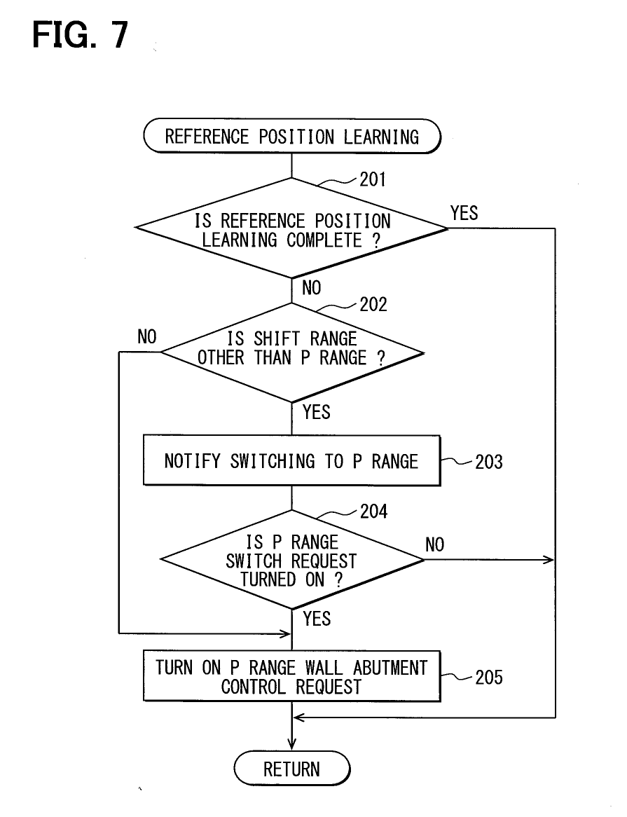

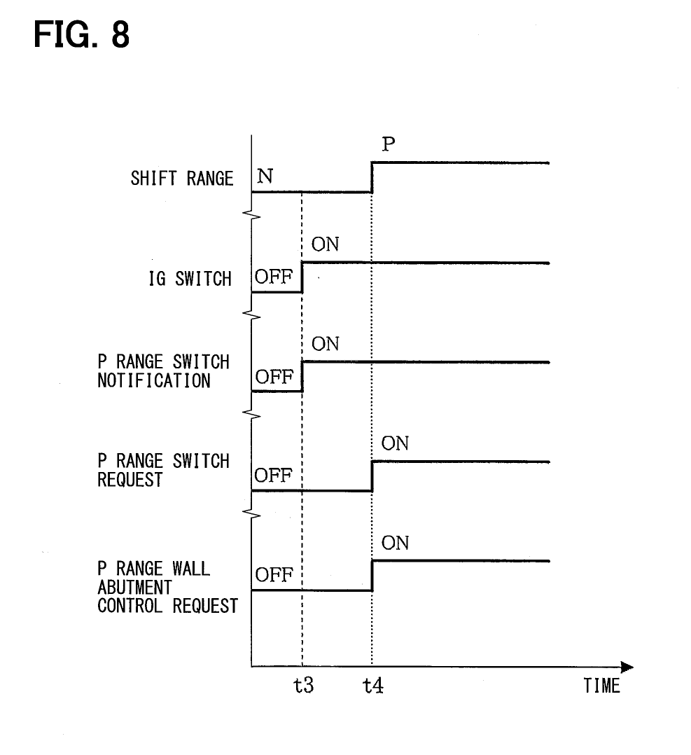

The second embodiment of the present disclosure is described with reference to FIGS. 7 and 8 in the following. Description of substantially same contents as the first embodiment is either abbreviated or omitted, and the description of the second embodiment focuses on differences from the first embodiment.

In the second embodiment, the microcomputer 41 of the range switching controller 42 performs a reference position learning routine in FIG. 7 which is described in the following, for the abutment control in an other-than abutted shift range situation. That is, when the shift range is a range other than the P range (i.e., the R range, or the N range, or the D range) at a time of starting the microcomputer 41, the microcomputer 41 notifies a driver that the shift range should be switched to the P range (i.e., to the abutted shift range), and, when a switching request for switching the shift range to the P range is generated by the driver's operation, the microcomputer 41 switches, determining that the switch permission condition is being fulfilled, the shift range to the P range for performing the abutment control and for learning the reference position.

The reference position learning routine of FIG. 7 first determines in Step 201 whether the reference position learning is complete, and if it is determined that the reference position learning is not yet complete, the routine proceeds to Step 202, and it is determined whether the present shift range is a range other than the P range (i.e., the R range, the N range, or the D range).

At Step 202, when it is determined that the present shift range is the P range, the routine proceeds to Step 205, and the routine turns ON the P range wall abutment control request. Thereby, the P range wall abutment control is performed, and the P range side limit position is learned as a reference position.

On the other hand, when it is determined that the present shift range is a range other than the P range in the above-mentioned Step 202, the routine proceeds to Step 203, and it notifies a driver that he/she should switch the shift range to the P range. In this case, for example, a message “Please switch to the P range” or the like may be displayed on a display screen on an instrument panel (not illustrated). Alternatively, the vocal guidance message “Please switch to the P range” or the like may be output.

Then, the routine proceeds to Step 204, and it is determined whether the switch permission condition is fulfilled based on whether the P range switching request is ON. The P range switching request is turned ON when a request for switching the shift range to the P range is generated by the driver's operation (e.g., when the target shift range is switched to the P range).

When it is determined that the P range switching request is OFF (i.e., a request for switching the shift range to the P range has not been generated) in Step 204, the routine determines that the switch permission condition is not being fulfilled, and the routine is ended.

Then, when it is determined that the P range switching request is ON (i.e., the request for switching the shift range to the P range has been generated) in the above-mentioned Step 204, the routine determines that the switch permission condition is being fulfilled, and the shift range is switched to the P range. Then, the routine proceeds to Step 205, and the routine turns ON the P range wall abutment control request. In such manner, the P range wall abutment control is performed, and the P range side limit position is learned as a reference position.

An example of how the reference position learning is performed in the second embodiment is described with reference to a time chart in FIG. 8.

As shown in FIG. 8, at a time of starting the microcomputer 41 of the range switching controller 42, if the shift range is the N range, the driver is notified that the shift range should be switched to the P range at such time of t3.

Then, based on whether the P range switching request is ON (i.e., whether the request for switching the shift range to the P range is generated by the shift operation of the driver), it is determined whether the switch permission condition is being fulfilled. Then, at a time t4 when it is determined that the P range switching request is ON, the routine determines that the switch permission condition is being fulfilled, and the shift range is switched to the P range. Further, by turning ON the P range wall abutment control request, the P range wall abutment control is performed, and the P range side limit position is learned as a reference position.

In the above-described second embodiment, when the shift range is a range other than the P range at a time of starting the microcomputer 41, the driver is notified that the shift range should be switched to the P range. When the switching request for switching the shift range to the P range is generated by the driver's operation, the microcomputer 41 switches, determining that the switch permission condition is being fulfilled, the shift range to the P range for performing the abutment control and learning the reference position. Therefore, without causing a strange feeling to the driver, the shift range is switched to the P range and the reference position is learned by performing the P range wall abutment control.

### Third Embodiment

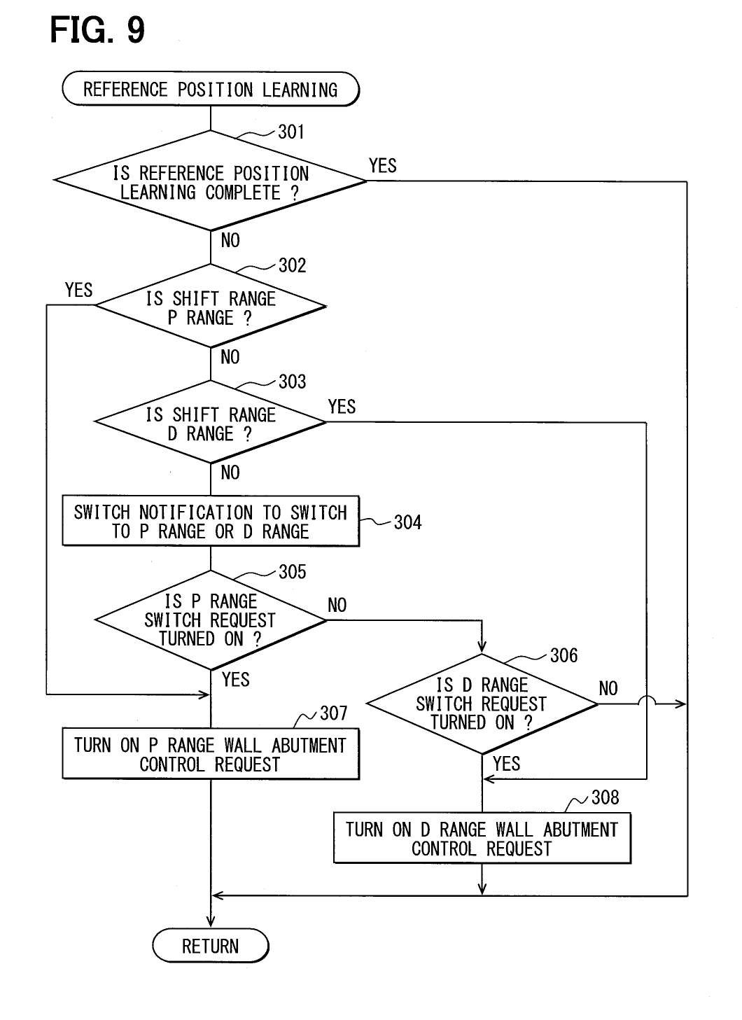

The third embodiment of the present disclosure is described with reference to FIG. 9 in the following. Description of substantially same contents as the first/second embodiments is either abbreviated or omitted, and the description of the third embodiment has its focus on differences from the first/second embodiments.

In the third embodiment, the P range and the D range of the range switch mechanism 11 are configured to be the abutted shift ranges (i.e., a range in which the abutment control is performable).

Therefore, when the shift range is the P range, the “P range wall abutment control” is performed, which rotates the motor 12 until the engagement part 23a of the detent spring 23 abuts against the P range wall (i.e., a side wall of the P range detention concave part 24), which is the limit position on the P range side of the movable range of the range switch mechanism 11, and by which the limit position on the P range side is learned as a reference position.

Further, when the shift range is the D range, a “D range wall abutment control” is performed, which rotates the motor 12 until the engagement part 23a of the detent spring 23 abuts against a D range wall (i.e., a side wall of a D range detention concave part 24), which is the limit position on a D range side of the movable range of the range switch mechanism 11, and by which the limit position on the D range side is learned as a reference position.

In the third embodiment, the reference position learning routine in FIG. 9 mentioned later is performed by the microcomputer 41 of the range switching controller 42, and the driver of the vehicle is notified that the shift range should be switched to either the P range or the D range when the shift range at a time of starting the microcomputer 41 is a range other than the P or D range (i.e., the R range or the N range). Then, in case that a request for switching the shift range to the P range is generated by the driver's operation, the shift range is switched to the P range, the P range wall abutment control is performed, and a reference position is learned. On the other hand, in case that a request for switching the shift range to the D range is generated by the driver's operation, the shift range is switched to the D range, and the D range wall abutment control is performed, and a reference position is learned.

In the reference position learning routine of FIG. 9, when the routine determines first in Step 301 whether the reference position learning is complete, and, when it is determined that the reference position learning is not complete, the routine proceeds to Step 302, and it is determined whether the present shift range is the P range. In Step 302, when it is determined that the present shift range is the P range, the routine proceeds to Step 307, and the routine turns ON the P range wall abutment control request. In such manner, the P range wall abutment control is performed, and the P range side limit position is learned as a reference position.

On the other hand, when it is determined that the present shift range is not the P range in the above-mentioned Step 302, the routine proceeds to Step 303, and it is determined whether the present shift range is the D range. In Step 303, when it is determined that the present shift range is D range, the routine proceeds to Step 308, and a D range wall abutment control request is turned ON. In such manner, the D range wall abutment control is performed, and the D range side limit position is learned as a reference position.

Further, when it is determined that the present shift range is not the P range in the above-mentioned Step 302 and when it is determined that the present shift range is not the D range in the above-mentioned Step 303, the routine proceeds to Step 304, and the driver is notified that he/she should switch the shift range to the P range or the D range. In this case, for example, a message “Please switch to the P range or to the D range” or the like may be displayed on the display screen on the instrument panel. Alternatively, the vocal guidance message “Please switch to the P range or to the D range” or the like may be output.

Then, the routine proceeds to Step 305, and it is determined whether the P range switching request is ON. The P range switching request is turned ON when a request for switching the shift range to the P range is generated by the driver's operation (e.g., when the target range is switched to the P range).

When it is determined that the P range switching request is OFF (i.e., the request for switching the shift range to the P range has not been generated) at Step 305, the routine proceeds to Step 306, and it is determined whether a D range switching request is ON. The D range switching request is turned ON when a request for switching the shift range to the D range is generated by the driver's operation (e.g., when the target range is switched to the D range).

At Step 306, when it is determined that the D range switching request is OFF (i.e., the request for switching the shift range to the D range has not been generated), the routine determines that the switch permission condition is not being fulfilled, and the routine is ended.

Then, in the above-mentioned Step 305, when it is determined that the P range switching request is ON (i.e., the request for switching the shift range to the P range occurred), the routine determines that the switch permission condition is being fulfilled, and the shift range is switched to the P range. Then, the routine proceeds to Step 307, and the routine turns ON the P range wall abutment control request. In such manner, the P range wall abutment control is performed, and the P range side limit position is learned as a reference position.

On the other hand, in the above-mentioned Step 306, when it is determined that the D range switching request is ON (i.e., the request for switching the shift range to D range has been generated), the routine determines that the switch permission condition is being fulfilled, and the shift range is switched to the D range. Then, the routine proceeds to Step 308, and the D range wall abutment control request is turned ON. In such manner, the D range wall abutment control is performed, and the D range side limit position is learned as a reference position.

In the third embodiment described above, when the shift range is a range other than the P range and the D range at a time of starting the microcomputer 41, the driver is notified that the shift range should be switched to the P range or to the D range. Further, when a request for switching the shift range to the P range is generated by the driver's operation, the shift range is switched to the P range, and the P range wall abutment control is performed, and a reference position is learned. In such manner, without causing a strange feeling to the driver, the shift range is switched to the P range, and the P range wall abutment control is performed, and a reference position is learned. On the other hand, when a request for switching the shift range to the D range is generated by the driver's operation, the shift range is switched to the D range, and the D range wall abutment control is performed, and a reference position is learned. In such manner, without causing a strange feeling to the driver, the shift range is switched to the D range, and the D range wall abutment control is performed, and a reference position is learned.

In each of the above-mentioned first to third embodiments, a magnetic type encoder is used as the encoder 46. However, an optical type encoder or a brush type encoder may also be used as the encoder 46, for example. Further, the encoder 46 is not necessarily limited to the one which outputs an A phase signal and a B phase signal, but may also be the one which outputs a Z phase signal for correction (i.e., index) purpose, in addition to the NB phase signals.

Further, the switched-reluctance motor (i.e. an SR motor) used in each of the above-mentioned first to third embodiments as the motor 12 may also be other brushless type motors as long as the power supply phase of such motor is sequentially switched based on a rotation position of the motor detected by the count value of the output signal from the encoder.

Further, although the present disclosure is applied to a system that is provided with the range switch mechanism for switching the shift range between the P range, the R range, the N range, and the D range, i.e., among four ranges, in each of the above-mentioned first to third embodiments, the present disclosure may also be applicable to a system that is provided with a range switch mechanism for switching between the P range and a non-P range, between two ranges. Furthermore, the present disclosure may further be applicable to a system that is provided with a range switch mechanism for switching among three ranges or among multiple ranges, e.g., five or more ranges.

Further, the present disclosure is applicable not only to an automatic transmission mechanism (i.e., AT, CVT, DCT, etc.), but also to a range switching device for switching the shift ranges in a speed reducer for an electric vehicle or the like.

Although the present disclosure has been fully described in connection with preferred embodiment thereof with reference to the accompanying drawings, it is to be noted that various changes and modifications will become apparent to those skilled in the art, and such changes, modifications, and summarized schemes are to be understood as being within the scope of the present disclosure as defined by appended claims.

What is claimed is:

1. A range switching device comprising:
a range switch mechanism having a plurality of shift ranges;
a motor driving the range switching mechanism to switch a shift range between one of the plurality of shift ranges; and
a control unit controlling the motor to rotate the range switching mechanism to the shift range, wherein
the control unit determines
(A) in the range switching device that is configured to rotate the motor after a start of operation of the control unit and perform an abutment control in which the motor is rotated to a limit position of the range switch mechanism and learns a reference position, whether the shift range is an abutted shift range that allows the abutment control to be performed at the start of operation of the control unit, and
(B) if the shift range is determined to be a shift range other than the abutted shift range, the control unit determines whether a predetermined switch permission condition is fulfilled, and
(C) if the predetermined switch permission condition is fulfilled, the control unit switches the shift range to the abutted shift range and learns the reference position based on a limit position of the abutted shift range.

2. The range switching device of claim 1, wherein
the predetermined switch permission condition is fulfilled when a brake is ON.

3. The range switching device of claim 2, wherein
the predetermined switch permission condition is fulfilled when the brake is ON and an ignition switch is ON.

4. The range switching device of claim 1, wherein
the control unit notifies that the shift range should be switched to the abutted shift range when the shift range at the start of operation of the control unit is the shift range other than the abutted shift range, and
the predetermined switch permission condition is fulfilled when a request to switch the shift range to the abutted shift range is generated.
